(19) United States
(12) Patent Application Publication
(10) Pub. No.: US 2026/0167084 A1
(43) Pub. Date: Jun. 18, 2026

(54) METHOD FOR ESTIMATING INSTANTANEOUS POWDER DISCHARGE AMOUNT OF BULK TRAILER AUTOMATIC DISCHARGE SYSTEM

(71) Applicant: HANKYONG NATIONAL UNIVERSITY INDUSTRY-ACADEMIC COOPERATION FOUNDATION, Ansung-si, Gyeonggi-do (KR)

(72) Inventors: Jung Keun LEE, Ansung-si, Gyeonggi-do (KR); Chang June LEE, Seoul (KR)

(73) Assignee: HANKYONG NATIONAL UNIVERSITY INDUSTRY-ACADEMIC COOPERATION FOUNDATION, Ansung-si, Gyeonggi-do (KR)

(21) Appl. No.: 19/127,092

(22) PCT Filed: Nov. 6, 2023
(86) PCT No.: PCT/KR2023/017656

§ 371 Date: May 2, 2025

(30) Foreign Application Priority Data
Nov. 23, 2022 (KR) 10-2022-0158176

(51) Int. Cl. B60P 3/22; B60G 17/018; G06N 20/00

(52) U.S. Cl. CPC B60P 3/228; B60G 17/018; B60P 3/2245; B60P 3/225; G06N 20/00; B60Y 2200/147

(57) ABSTRACT

A method for estimating an instantaneous powder discharge amount of a bulk trailer automatic discharge system, suitable for estimating an instantaneous powder discharge amount using state parameters related with a powder discharge operation of a bulk trailer, includes (a) obtaining state parameters and a powder discharge amount related with the powder discharge operation for each case; (b) building a database by relating the powder discharge amount with the state parameters; (c) building, using the database, a machine learning model for predicting an instantaneous powder discharge amount depending on pressure values of respective components of the bulk trailer among the state parameters; (d) measuring at least one state parameter among the state parameters during the powder discharge operation, and receiving the at least one state parameter as an input parameter; and (e) estimating an instantaneous powder discharge amount by applying the input parameter to the machine learning model.

### TECHNICAL FIELD

The present disclosure relates to a method for estimating an instantaneous powder discharge amount of a bulk trailer automatic discharge system, capable of estimating an instantaneous powder discharge amount through machine learning using state parameters related with a powder discharge operation as input values in a system that automatically discharges powder received in the storage tank of a bulk trailer.

### BACKGROUND ART

In general, a bulk trailer is a large transport trailer that transports powders such as cement, coal ash and construction powder. The bulk trailer typically has a plurality of of hoppers at the lower end of a storage tank that receives powder, and, after transporting the powder to a destination, discharges the powder poured out through hopper discharge ports into an external storage facility (such as a silo).

In the past, a canvas made of fabric is installed at the lower end of each hopper of the bulk trailer, and vibration is induced in the canvas to increase powder discharge performance. However, the method of discharging powder using a canvas has problems in that a means for preventing damage to or sagging of the canvas is required and the canvas needs to be replaced and maintained periodically. In addition, there is a problem that powder discharge speed markedly slows down when the canvas does not maintain proper tension.

Recently, a powder discharge system has been developed that includes a discharge pipe crossing the hopper discharge ports of a bulk trailer and in which an air compressor is connected to the end of the discharge pipe so that powder freely falling from hoppers is discharged to the outside through the discharge pipe by high-pressure air. In order to maximize discharge speed in the powder discharge system of the bulk trailer, it is necessary to feedback control the opening amount of each hopper discharge port depending on the discharge amount of powder.

However, while it is easy to measure the discharge amount of a fluid using a flow meter, it is difficult to accurately measure the discharge amount of a powder. In addition, a substantially expensive flow meter is required for precise measurement, and its volume and weight are considerable, making it difficult to install permanently the flow meter on the bulk trailer.

### DISCLOSURE

### Technical Problem

Embodiments of the present disclosure are directed to providing a method for estimating an instantaneous powder discharge amount of a bulk trailer automatic discharge system, capable of performing hopper opening amount control according to an estimated value and significantly reducing a powder discharge time, by building a database through relating state parameters associated with a powder discharge operation of a bulk trailer with a powder discharge amount, by building a machine learning model for predicting an instantaneous powder discharge amount using the database and by estimating an instantaneous powder discharge amount through applying input parameters such as pressure data at a plurality of locations to the machine learning model without using a discharge amount measurement means such as a flow meter in an actual bulk trailer environment.

### Technical Solution

In an embodiment, a method for estimating an instantaneous powder discharge amount of a bulk trailer automatic discharge system, installed in an automatic powder discharge system of a bulk trailer configured such that a plurality of hoppers are formed at the lower end of a storage tank for storing powder, discharge valves are installed at the discharge ports of the respective hoppers and high-pressure air is supplied from one end of a discharge pipe crossing the discharge ports of the hoppers to discharge the powder, the method being suitable for estimating an instantaneous powder discharge amount using state parameters related with a powder discharge operation of the bulk trailer, may include: (a) obtaining a plurality of state parameters and a powder discharge amount related with the powder discharge operation of the bulk trailer for each case; (b) building a database by relating the powder discharge amount with the state parameters; (c) building, using the database, a machine learning model for predicting an instantaneous powder discharge amount depending on pressure values of respective components of the bulk trailer among the state parameters; (d) measuring at least one state parameter among the state parameters during the powder discharge operation of the bulk trailer, and receiving the at least one state parameter as an input parameter; and (e) estimating an instantaneous powder discharge amount by applying the input parameter to the machine learning model.

In another embodiment, (a) obtains the powder discharge amount by temporarily installing a flow meter or a precision scale at the end of the discharge pipe.

In another embodiment, the state parameters include a pressure signal (P1) of the storage tank, a pressure signal (P2) of an air supply pipe that supplies air to the discharge pipe, and a first suspension pressure signal (P3) applied to the suspension of a first axle among rear axles of the bulk trailer.

In another embodiment, the state parameters further include a second suspension pressure signal (P4) applied to the suspension of a second axle disposed at the rear of the first axle.

In another embodiment, the state parameters further include hopper powder depth signals (D1, D2 and D3) received from depth sensors that are installed at the upper parts of the respective hoppers and measure the depths of powder received in the hoppers.

In another embodiment, the state parameters further include an opening amount signal (M1) of a main valve of the air supply pipe and opening amount signals (M2, M3 and M4) of the discharge valves installed at the discharge ports of the respective hoppers.

### Advantageous Effects

According to the method for estimating an instantaneous powder discharge amount of a bulk trailer automatic discharge system of the present disclosure, effects are provided in that it is possible to perform hopper opening amount control according to an estimated value and significantly reduce a powder discharge time, by building a database through relating state parameters associated with a powder discharge operation of a bulk trailer with a powder discharge amount, by building a machine learning model for predicting an instantaneous powder discharge amount using the database and by estimating an instantaneous powder discharge amount through applying input parameters such as pressure data at a plurality of locations to the machine learning model without using a discharge amount measurement means such as a flow meter in an actual bulk trailer environment.

### BRIEF DESCRIPTION OF DRAWINGS

FIG. 1 is a diagram illustrating the schematic configuration of a bulk trailer.

FIG. 2 is a diagram showing an example of measuring a powder discharge amount for each case.

FIG. 3 is a block diagram illustrating a bulk trailer automatic discharge system.

FIG. 4 is a flowchart showing a method for estimating an instantaneous powder discharge amount of a bulk trailer automatic discharge system according to the present disclosure.

FIG. 5 is a block diagram illustrating a machine learning model in which the method for estimating an instantaneous powder discharge amount according to the present disclosure is implemented.

### MODE FOR DISCLOSURE

Specific embodiments according to the present disclosure will be described below with reference to the accompanying drawings. However, this is not intended to limit the present disclosure to any particular embodiment, and is to be understood to include all modifications, equivalents, and substitutions that fall within the idea and technical scope of the present disclosure.

Throughout the specification, parts having like configuration and operation are designated by the same reference signs. In addition, the accompanying drawings of the present disclosure are for the sake of convenience in illustration only, and shapes and relative dimensions thereof may be exaggerated or omitted.

In describing embodiments in detail, redundant descriptions or descriptions of techniques that are obvious to those skilled in the art are omitted. In addition, when it is mentioned in the following description that any component “includes” another component, it may be intended to include a component in addition to those mentioned, unless otherwise specifically stated.

In addition, terms such as “part,” “section,” “module” and the like used herein mean a unit that performs at least one function or operation, which may be implemented in hardware, software or a combination of hardware and software. Also, when it is mentioned that one part is electrically connected to another part, this includes not only direct connections but also connections with other configurations interposed therebetween.

Terms including ordinal numbers, such as first, second and the like, may be used to describe various components, but the components are not limited by such terms. These terms are used only to distinguish one component from another. For example, without departing from the scope of the present disclosure, a second component may be named a first component, and similarly, the first component may be named the second component.

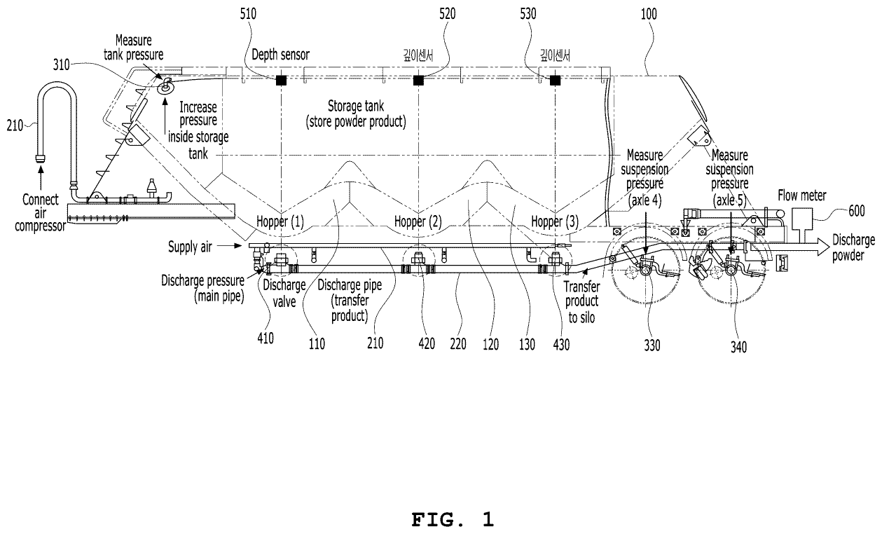

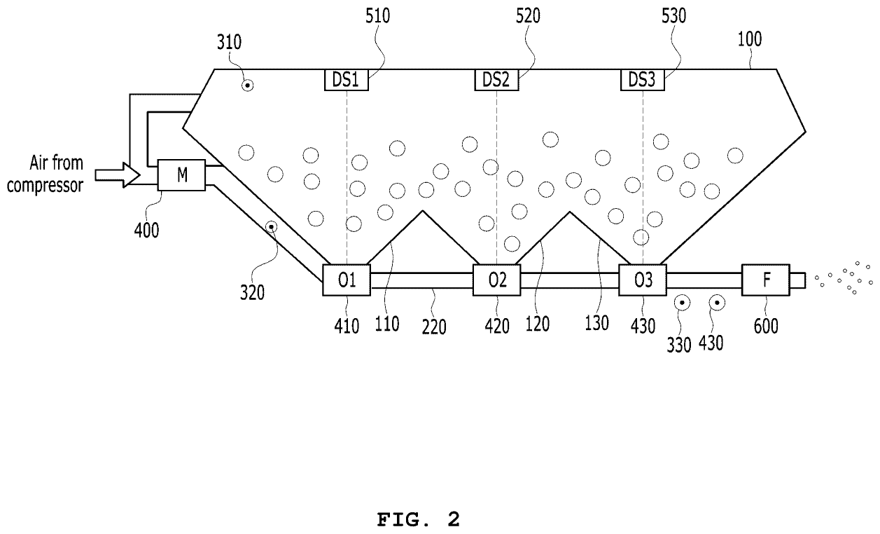

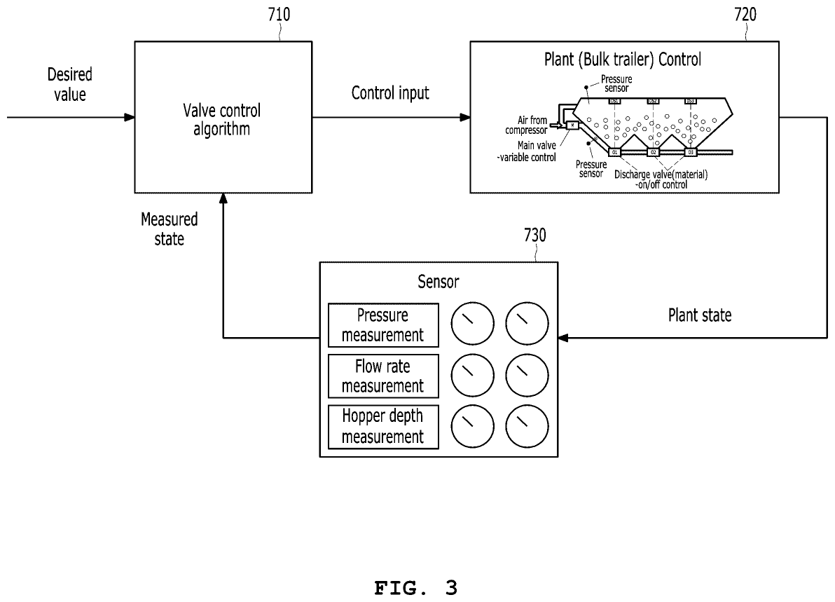

FIG. 1 is a diagram illustrating the schematic configuration of a bulk trailer, FIG. 2 is a diagram showing an example of measuring a powder discharge amount for each case, and FIG. 3 is a block diagram illustrating a bulk trailer automatic discharge system.

Referring to FIG. 1, a bulk trailer to which the present disclosure is applied is a transport trailer that transports powders such as cement, coal ash and construction powder, and is provided with a plurality of hoppers 110, 120 and 130 at the lower end of a storage tank 100 that stores powder. Each of the hoppers 110, 120 and 130 has a funnel shape, and in the present embodiment, the bulk trailer has three hoppers 110, 120 and 130.

An air compressor (not illustrated) is installed at the front of the vehicle when viewed on the storage tank 100, and an air supply pipe 210 that is connected to the air compressor is disposed along the bottom line of the storage tank 100. The discharge port of each of the first hopper 110, the second hopper 120 and the third hopper 130 is connected to a discharge pipe 220 that crosses the bottom part of the vehicle. One end of the discharge pipe 220 is connected to the air supply pipe 210, and powder falling through the discharge port of each hopper is discharged to a discharge location such as a silo through the discharge pipe 220 by high-pressure air.

The instantaneous powder discharge amount estimation method of the bulk trailer automatic discharge system of the present disclosure estimates an instantaneous powder discharge amount using state parameters related with a powder discharge operation. It is well known in the art to directly measure a powder discharge amount by installing a flow meter or a precision scale at the end of the discharge pipe 220. However, it requires a substantial cost to install a flow meter or a precision scale on each bulk trailer. In addition, precise measurement requires a measurement device with large volume and weight, and a separate calibration process is required. Therefore, it is not desirable to directly install such a measurement device on the bulk trailer that frequently moves on the road.

Meanwhile, pressure signals that are measured in the storage tank 100, the air supply pipe 210, the suspensions of the bulk trailer, etc. correspond to state parameters corresponding to loads applied to axles, and these state parameters are values that change depending on the amount of powder received in the storage tank 100. The present disclosure estimates an instantaneous powder discharge amount by using changes in pressures. To this end, a first pressure measurement means 310 for measuring a pressure inside the storage tank 100 is installed on the storage tank 100, and a second pressure measurement means 320 for measuring a pressure inside the air supply pipe 210 is installed on the air supply pipe 210. In addition, in order to determine changes in load applied to the axles, a third pressure measurement means 330 for measuring a first suspension pressure is installed on the suspension of the fourth axle of the bulk trailer, and a fourth pressure measurement means 340 for measuring a second suspension pressure is installed on the suspension of the fifth axle of the bulk trailer. By observing changes in pressure of the suspensions of the two axles, a change in powder discharge amount corresponding to a change in the load of powder in each of the plurality of hoppers 110, 120 and 130 may be more accurately determined.

Referring to FIG. 2, a main valve 400 that opens and closes the supply of high-pressure air is installed at the input end of the discharge pipe 220. A first discharge valve 410 is installed at the discharge port of the first hopper 110, a second discharge valve 420 is installed at the discharge port of the second hopper 120, and a third discharge valve 430 is installed at the discharge port of the third hopper 130. The opening amount signals of these valves 400, 410, 420 and 430 correspond to state parameters that are closely related with the discharge of powder. The opening amounts of the valves 400, 410, 420 and 430 are values that may be controlled by the automatic powder discharge system, and correspond to parameters that may be easily obtained. As an instantaneous powder discharge amount estimated according to the present disclosure approximates an actual instantaneous powder discharge amount, the time required to completely discharge powder may be significantly shortened by appropriately adjusting the opening/closing order and the opening amount control values of the valves 400, 410, 420 and 430.

Since powder is not a fluid, the powder does not flow out with the same height within the respective hoppers 110, 120 and 130, and a tilting occurs. That is to say, a left-right tilting occurs within the hoppers 110, 120 and 130. A height deviation may vary depending on the discharge speed of the powder, and the height of the powder may also be a factor that determines a powder discharge amount. In the present disclosure, a first depth sensor 510 is installed at the central upper end of the first hopper 110, a second depth sensor 520 is installed at the central upper end of the second hopper 120, and a third depth sensor 530 is installed at the central upper end of the third hopper 130. In this way, by measuring changes in the depth of powder in the respective hoppers 110, 120 and 130, a change in powder discharge amount may be more accurately determined.

The method for estimating an instantaneous powder discharge amount of the bulk trailer automatic discharge system of the present disclosure provides a method for estimating an instantaneous powder discharge amount through machine learning. In order to build a machine learning model, it is necessary to obtain a truth reference, and to this end, it is necessary to build a database by performing simulation experiments for various cases (kinematic shapes of a bulk trailer and a storage tank, the types of powder and powder storage amounts). In order to build a database, a flow meter 600 or a precision scale is installed at the end of the discharge pipe 220 as illustrated in FIG. 1 and FIG. 2 in a simulation experiment environment for each case.

Referring to FIG. 3, the bulk trailer automatic discharge system for database building is configured to include a valve control unit 710, a plant control unit 720 and a sensing unit 730.

The valve control unit 710 receives a valve control value or calls a processing routine stored in memory, and performs control on the main valve 400, the first discharge valve 410, the second discharge valve 420 and the third discharge valve 430. The plant control unit 720 controls each valve according to the control signal of the valve control unit 710 to perform a powder discharge operation. The sensing unit 730 collects pressure signals from the pressure measurement means 310, 320, 330 and 340 described above, collects a powder discharge amount from the flow meter 600, and collects depth signals from the depth sensors 510, 520 and 530. The sensing signals collected in the sensing unit 730 are provided as feedback signals to the valve control unit 710, and the valve control unit 710 controls the opening amounts of the valves 400, 410, 420 and 430 according to the sensing signals.

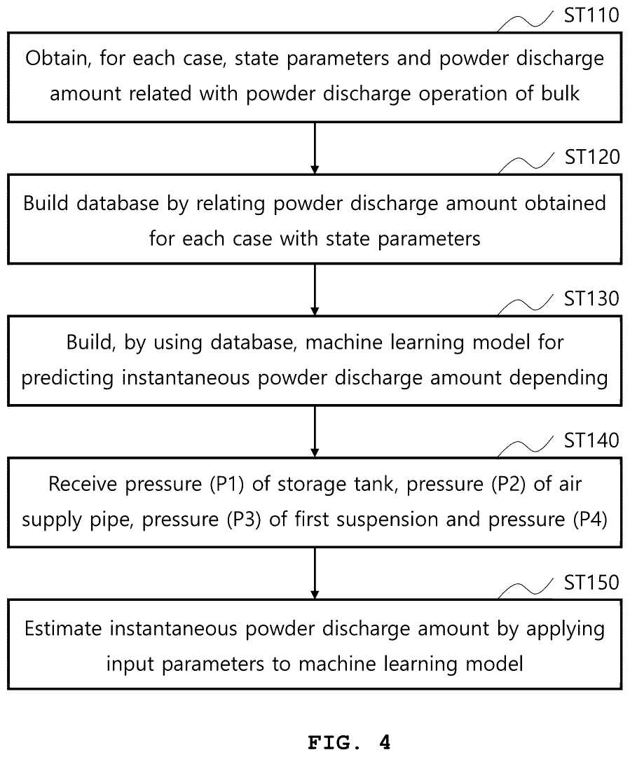

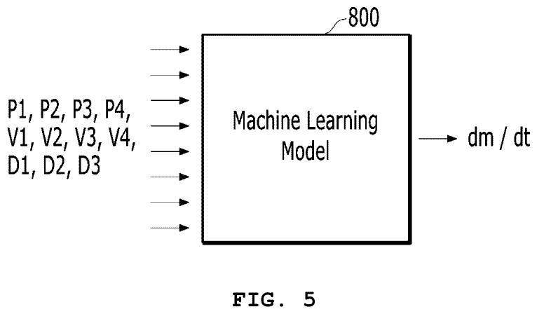

FIG. 4 is a flowchart showing a method for estimating an instantaneous powder discharge amount of a bulk trailer automatic discharge system according to the present disclosure, and FIG. 5 is a block diagram illustrating a machine learning model in which the method for estimating an instantaneous powder discharge amount according to the present disclosure is implemented.

FIG. 4 illustrates a process of building a machine learning model 800 according to the present disclosure and estimating an instantaneous powder discharge amount in an actual bulk trailer environment with a flow meter removed. Although not illustrated as an example, an instantaneous powder discharge amount estimation system may include an input unit, a processor and memory. The input unit is a means that receives state parameters related with a powder discharge operation. The memory is a means that stores a computer-readable instruction for performing a process, and the processor calls the memory for input parameters inputted through the input unit to perform machine learning as shown in the flow chart of FIG. 4. The process in which the machine learning is performed will be described hereunder with reference to FIG. 4.

First, a plurality of state parameters and a powder discharge amount related with the powder discharge operation of the bulk trailer are obtained for each case (ST110).

The powder discharge amount is a signal that is measured from the flow meter 600 or the precision scale. The state parameters include the pressure signals collected by the sensing unit 730 of the automatic powder discharge system as illustrated in FIG. 3. For example, the state parameters are a pressure signal P1 of the storage tank 100 measured by the first pressure measurement means 310, a pressure signal P2 of the air supply pipe 210 measured by the second pressure measurement means 320, a first suspension pressure signal P3 measured by the third pressure measurement means 330, and a second suspension pressure signal P4 measured by the fourth pressure measurement means 340.

In addition, the state parameters may include current valve opening amount state information according to the valve control algorithm of the valve control unit 710. For example, the state parameters may further include an opening amount signal M1 of the main valve 400, an opening amount signal M2 of the first discharge valve 410 installed at the discharge port of the first hopper 110, an opening amount signal M3 of the second discharge valve 420 installed at the discharge port of the second hopper 120, and an opening amount signal M4 of the third discharge valve 430 installed at the discharge port of the third hopper 130.

Also, the state parameters may include a powder depth signal in each hopper collected by the sensing unit 730. For example, the state parameters may further include a first hopper powder depth signal Dl measured by the first depth sensor 510, a second hopper powder depth signal D2 measured by the second depth sensor 520, and a third hopper powder depth signal D3 measured by the third depth sensor 530.

A database is built by relating a powder discharge amount obtained for each case with the state parameters (ST120). A database is built by relating the above-described state parameters and the powder discharge amount for each of cases in which the kinematic shapes of a bulk trailer and a storage tank, the type of powder and a powder storage amount are changed variously.

Next, a machine learning model for predicting an instantaneous powder discharge amount depending on pressure values of the respective components of the bulk trailer is built using the database (ST130). Here, the instantaneous powder discharge amount is a value that represents a mass discharged per unit time. As illustrated in FIG. 5, the machine learning model 800 is a learning model that generates, as an output, a differential value by which a powder discharge amount changes according to changes in the pressure signal Pl of the storage tank 100, the pressure signal P2 of the air supply pipe 210, the first suspension pressure signal P3 and the second suspension pressure signal P4, i.e., an instantaneous powder discharge amount. The machine learning model 800 is configured to include at least one neural network (filter). The machine learning model 800 is configured to learn innumerable number of cases and compare a result of a calculation for inputted state parameters with an actual value (a value obtained by differentiating a powder discharge amount obtained through the flow meter) stored in the database, thereby minimizing loss rate.

In an actual bulk trailer environment, the machine learning model 800 measures one or more state parameters during a powder discharge operation and receives the state parameters as input parameters (ST140). Basically, the pressure signal P1 of the storage tank 100, the pressure signal P2 of the air supply pipe 210, the first suspension pressure signal P3 and the second suspension pressure signal P4 are inputted. In addition, as shown in FIG. 5, the opening amount signal M1 of the main valve 400, the opening amount signal M2 of the first discharge valve 410, the opening amount signal M3 of the second discharge valve 420 and the opening amount signal M4 of the third discharge valve 430 may be further inputted. Moreover, the first hopper powder depth signal D1, the second hopper powder depth signal D2 and the third hopper powder depth signal D3 may be further inputted.

Finally, the machine learning model 800 estimates an optimal instantaneous powder discharge amount from results already learned by applying the inputted parameters to a neural network in the model even without using a powder discharge amount measurement means such as a flow meter or a precision scale (ST150).

An instantaneous powder discharge amount finally obtained through the present disclosure may be used as a feedback value for controlling the valves of the automatic discharge system of the bulk trailer as illustrated in FIG. 3. The automatic discharge system corrects control on the opening amounts of the valves 400, 410, 420 and 430 when an estimated instantaneous powder discharge amount decreases, thereby controlling a powder discharge speed to be maintained, whereby it is possible to significantly shorten the powder discharge time of the bulk trailer.

The present disclosure described above may be modified diversely without departing from the basic idea of the present disclosure. In other words, all of the above embodiments are to be construed as examples and not limiting. Accordingly, the protection scope of the present disclosure should be defined by the appended claims, not by the above embodiments, and any substitution of a component defined in the appended claims with an equivalent should be considered as falling within the protection scope of the present disclosure.

1. A method for estimating an instantaneous powder discharge amount of a bulk trailer automatic discharge system, installed in an automatic powder discharge system of a bulk trailer configured such that a plurality of hoppers are formed at the lower end of a storage tank for storing powder, discharge valves are installed at the discharge ports of the respective hoppers and high-pressure air is supplied from one end of a discharge pipe crossing the discharge ports of the hoppers to discharge the powder, the method being suitable for estimating an instantaneous powder discharge amount using state parameters related with a powder discharge operation of the bulk trailer, the method comprising:
(a) obtaining a plurality of state parameters and a powder discharge amount related with the powder discharge operation of the bulk trailer for each case;
(b) building a database by relating the powder discharge amount with the state parameters;
(c) building, using the database, a machine learning model for predicting an instantaneous powder discharge amount depending on pressure values of respective components of the bulk trailer among the state parameters;
(d) measuring at least one state parameter among the state parameters during the powder discharge operation of the bulk trailer, and receiving the at least one state parameter as an input parameter; and
(e) estimating an instantaneous powder discharge amount by applying the input parameter to the machine learning model.

2. The method according to claim 1, wherein (a) obtains the powder discharge amount by temporarily installing a flow meter or a precision scale at the end of the discharge pipe.

3. The method according to claim 1, wherein the state parameters include a pressure signal (P1) of the storage tank, a pressure signal (P2) of an air supply pipe that supplies air to the discharge pipe, and a first suspension pressure signal (P3) applied to the suspension of a first axle among rear axles of the bulk trailer.

4. The method according to claim 3, wherein the state parameters further include a second suspension pressure signal (P4) applied to the suspension of a second axle disposed at the rear of the first axle.

5. The method according to claim 3, wherein the state parameters further include hopper powder depth signals (D1, D2 and D3) received from depth sensors that are installed at the upper parts of the respective hoppers and measure the depths of powder received in the hoppers.

6. The method according to claim 4, wherein the state parameters further include hopper powder depth signals (D1, D2 and D3) received from depth sensors that are installed at the upper parts of the respective hoppers and measure the depths of powder received in the hoppers.

7. The method according to claim 3, wherein the state parameters further include an opening amount signal (M1) of a main valve of the air supply pipe and opening amount signals (M2, M3 and M4) of the discharge valves installed at the discharge ports of the respective hoppers.

8. The method according to claim 4, wherein the state parameters further include an opening amount signal (M1) of a main valve of the air supply pipe and opening amount signals (M2, M3 and M4) of the discharge valves installed at the discharge ports of the respective hoppers.
